(19) United States
(12) Patent Application Publication
(10) Pub. No.: US 2006/0168254 A1
(43) Pub. Date: Jul. 27, 2006

(54) Automatic policy selection

(76) Inventors: Scott J. Norton, San Jose, CA (US); Hyun J. Kim, Sunnyvale, CA (US); Swapneel Kekre, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/979,412

(22) Filed: Nov. 1, 2004

(51) Int. Cl. G06F 15/177; G06F 15/16

(52) U.S. Cl. 709/229; 709/220

(57) ABSTRACT

An arrangement, in a computer system, for coordinating scheduling of threads on a processor associated with a scheduling-enabled entity. The arrangement includes a policy database of scheduling policies. The arrangement further includes an automatic policy selector associated with the scheduling-enabled entity. The automatic policy selector is configured to automatically select one of the scheduling policies responsive to a triggering event that includes at least one of a first event and a second event. The first event represents a change in configuration of the scheduling-enabled entity and the second event represents a policy selection from a human operator. One of the scheduling policies is employed to schedule the threads on the processors after being selected by the automatic policy selector.

### CROSS REFERENCE TO RELATED APPLICATIONS

The present invention is related to the following applications, all of which are incorporated herein by reference:

Commonly assigned application titled “PER PROCESSOR SET SCHEDULING,” filed on even date herewith by the same inventors herein (Attorney Docket Number 200400231-1), and

Commonly assigned application titled “ADAPTIVE COOPERATIVE SCHEDULING,” filed on even date herewith by the same inventors herein (Attorney Docket Number 200400224-1).

### BACKGROUND OF THE INVENTION

Processor set (PSET) arrangements have been employed to manage processor resources in a multi-processor computer system. In a multi-processor computer system, the processors may be partitioned into various processor sets (PSETs), each of which may have any number of processors. Applications executing on the system are then assigned to specific PSETs. Since processors in a PSET do not share their processing resources with processors in another PSET, the use of PSETs renders it possible to guarantee an application or a set of applications a guaranteed level of processor resources.

To facilitate discussion, FIG. 1A shows a plurality of processors 102, 104, 106, 108, 110, 112, 114 and 116. In the example of FIG. 1A, processors 102, 104, and 106 are partitioned in a PSET 120, processors 108 and 110 are partitioned in a PSET 122, processor 112 is partitioned in a PSET 124, and processors 114 and 116 are partitioned in a PSET 126. An application 140 assigned to execute in PSET 120 may employ the processing resources of processors 102, 104, and 106 but would not be able to have its threads executed on processor 112 of PSET 124. In this manner, an application 142 assigned to execute in PSET 124 can be assured that the processing resources of processor 112 therein would not be taken up by applications assigned to execute in other PSETs.

However, when it comes to scheduling, the scheduling resources of the thread launcher, the thread balancer, and the thread stealer policies are still applied on a system-wide basis. To elaborate, in a computer system, a scheduler subsystem is often employed to schedule threads for execution on the various processors. One major function of the scheduler subsystem is to ensure an even distribution of work among the processors so that one processor is not overloaded while others are idle.

In a modern operating system, such as the HP-UX® operating system by the Hewlett-Packard Company of Palo Alto, Calif., as well as in many modern Unix and Linux operating systems, the scheduler subsystem may include three components: the thread launcher, the thread balancer, and the thread stealer.

With reference to FIG. 1B, kernel 152 may include, in addition to other subsystems such as virtual memory subsystem 154, I/O subsystem 156, file subsystem 158, networking subsystem 160, process management subsystem 162, a scheduler subsystem 164. As shown, scheduler subsystem 164 includes three components: a thread launcher 170, a thread balancer 172, and a thread stealer 174. These three components are coupled to a thread dispatcher 188, which is responsible for placing threads onto the processor's per-processor run queues as will be discussed herein.

Thread launcher 170 represents the mechanism for launching a thread on a designated processor, e.g., when the thread is started or when the thread is restarted after having been blocked and put on a per-processor run queue (PPRQ). As is known, a per-processor run queue (PPRQ) is a priority-based queue associated with a processor. FIG. 1B shows four example PPRQs 176a, 176b, 176c, and 176d corresponding to CPUs 178a, 178b, 178c, and 178d as shown.

In the PPRQ, threads are queued up for execution by the associated processor according to the priority value of each thread. In an implementation, for example, threads are put into a priority band in the PPRQ, with threads in the same priority band being queued up on a first-come-first-serve basis. For each PPRQ, the kernel then schedules the threads therein for execution based on the priority band value.

To maximize performance, thread launcher 170 typically launches a thread on the least-loaded CPU. That is, thread launcher 170 instructs thread dispatcher 188 to place the thread into the PPRQ of the least-loaded CPU that it identifies. Thus, at least one piece of data calculated by thread launcher 170 relates the least-loaded CPU ID, as shown by reference number 180.

Thread balancer 172 represents the mechanism for shifting threads among PPRQs of various processors. Typically, thread balancer 172 calculates the most loaded processor and the least loaded processor among the processors, and shifts one or more threads from the most loaded processor to the least loaded processor each time thread balancer 172 executes. Accordingly, at least two pieces of data calculated by thread balancer 172 relate to the most loaded CPU ID 182 and the least loaded CPU ID 184.

Thread stealer 174 represents the mechanism that allows an idle CPU (i.e., one without a thread to be executed in its own PPRQ) to “steal” a thread from another CPU. Thread stealer accomplishes this by calculating the most loaded CPU and shifts a thread from the PPRQ of the most loaded CPU that it identifies to its own PPRQ. Thus, at least one piece of data calculated by thread stealer 174 relates the most-loaded CPU ID. The thread stealer performs this calculation among the CPUs of the system, whose CPU IDs are kept in a CPU ID list 186.

In a typical operating system, thread launcher 170, thread balancer 172, and thread stealer 174 represent independently operating components. Since each may execute its own algorithm for calculating the needed data (e.g., least-loaded CPU ID 180, most-loaded CPU ID 182, least-loaded CPU ID 184, the most-loaded CPU ID among the CPUs in CPU ID list 186), and the algorithm may be executed based on data gathered at different times, each component may have a different idea about the CPUs at the time it performs its respective task. For example, thread launcher 170 may gather data at a time t1 and executes its algorithm, which results in the conclusion that the least loaded CPU 180 is CPU 178c. Thread balancer 172 may gather data at a time t2 and executes its algorithm, which results in the conclusion that the least loaded CPU 184 is a different CPU 178a. In this case, both thread launcher 170 and thread balancer 172 may operate correctly according to its own algorithm. Yet, by failing to coordinate (i.e., by executing their own algorithms and/or gathering system data at different times), they arrive at different calculated values.

The risk is increased for an installed OS that has been through a few update cycles. If the algorithm in one of the components (e.g., in thread launcher 170) is updated but there is no corresponding update in another component (e.g., in thread balancer 172), there is a substantial risk that these two components will fail to arrive at the same calculated value for the same scheduling parameter (e.g., the most loaded CPU ID).

The net effect is rather chaotic and unpredictable scheduling by scheduler subsystem 164. For example, it is possible for thread launcher 170 to believe that CPU 178a is the least loaded and would therefore place a thread A on PPRQ 176a associated with CPU 178a for execution. If thread stealer 174 is not coordinating its effort with thread launcher 170, it is possible for thread stealer 174 to believe, based on the data it obtained at some given time and based on its own algorithm, that CPU 178a is the most loaded. Accordingly, as soon as thread A is placed on the PPRQ 176a for execution on CPU 178a, thread stealer 174 immediately steals thread A and places it on PPRQ 176d associated with CPU 178d.

Further, if thread balancer 172 is not coordinating its effort with thread launcher 170 and thread stealer 174, it is possible for thread balancer 172 to believe, based on the data it obtained at some given time and based on its own algorithm, that CPU 178d is the most loaded and CPU 178a is the least loaded. Accordingly, as soon as thread A is placed on the PPRQ 176d for execution on CPU 178d, thread balancer 172 immediately moves thread A from PPRQ 176d back to PPRQ 176a, where it all started.

During this needless shifting of thread A among the PPRQs, the execution of thread A is needlessly delayed. Further, overhead associated with context switching is borne by the system. Furthermore, such needless shifting of threads among PPRQs may cause cache misses, which results in a waste of memory bandwidth. The effect on the overall performance of the computer system may be quite noticeable.

Furthermore, since the scheduling policies are the same for all PSETs, there may be instances when scheduling decisions regarding thread evacuation, load balancing, or thread stealing involve processors from different PSETs.

In other words, a single thread launching policy is applied across all processors irrespective of which PSET a particular processor is associated with. Likewise, a single thread balancing policy is applied across all processors and a single thread stealing policy is applied across all processors.

As can be appreciated from FIG. 1C, certain scheduling instructions from thread launcher 192, thread balancer 194, and thread stealer 196, such as those involving processors associated with different PSETs 198a, 198b, and 198c, must be disregarded by the dispatchers 199a, 199b, and 199c in the PSETs if processor partitioning integrity is to be observed. When such scheduling instructions are disregarded in order to maintain processor partition integrity within the PSETs, the threads are not scheduled in the most efficient manner, and the system processor bandwidth is also not utilized in the most efficient manner.

### SUMMARY OF INVENTION

The invention relates, in an embodiment, to an arrangement, in a computer system, for coordinating scheduling of threads on a plurality of processors associated with a scheduling-enabled entity. The arrangement includes a policy database having a plurality of scheduling policies. The arrangement further includes an automatic policy selector associated with the scheduling-enabled entity. The automatic policy selector is configured to automatically select one of the plurality of scheduling policies responsive to a triggering event from a set of triggering events that includes at least one of a first event and a second event. The first event represents a change in configuration of the scheduling-enabled entity and the second event represents a policy selection from a human operator. One of the plurality of scheduling policies is employed to schedule the threads on the plurality of processors after being selected by the automatic policy selector.

In another embodiment, the invention relates to an arrangement for scheduling threads on a first plurality of processors associated with a first processor set (PSET) of the plurality of PSETs, in a computer system having a plurality of processor sets (PSETs). The arrangement includes a first set of scheduling resources associated with the first PSET. The first set of scheduling resources includes at least two of a first thread launcher, a first thread balancer, and a first thread stealer. Also, the set of scheduling resources is configured to schedule threads assigned to the first PSET only among the first plurality of processors. The arrangement further includes a policy database having a plurality of scheduling policies. The arrangement also includes an automatic policy selector associated with the first PSET. The automatic policy selector is configured to automatically select one of the plurality of scheduling policies responsive to a triggering event from a set of triggering events that includes at least one of a first event and a second event. The first event represents a change in configuration of the scheduling-enabled entity and the second event represents a policy selection from a human operator. One of the plurality of scheduling policies is employed by the first set of scheduling resources to schedule the threads on the first plurality of processors after being selected by the automatic policy selector.

In yet another embodiment, the invention relates to a method for scheduling threads on a plurality of processors associated with a scheduling-enabled entity, in a computer system. The method includes ascertaining whether a triggering event has occurred. The method further includes, if the triggering event has occurred, automatically selecting a first scheduling policy and using an automatic policy selector, from a database of scheduling policies. The first scheduling policy represents a scheduling policy employed for scheduling the threads on the plurality of processors after the triggering event occurred. Also, the first scheduling policy is different than a policy that is employed for scheduling the threads before the triggering event occurred. Automatically selecting is performed without human intervention.

In yet another embodiment, the invention relates to an article of manufacture comprising a program storage medium having computer readable code embodied therein, the computer readable code being configured to schedule threads on a plurality of processors associated with a scheduling-enabled entity. There is included computer readable code for ascertaining whether a triggering event has occurred. There is further included computer readable code for automatically selecting, if the triggering event has occurred, a first scheduling policy from a database of scheduling policies. The first scheduling policy represents a scheduling policy employed for scheduling the threads on the plurality of processors after the triggering event occurred. Also, the first scheduling policy is different than a policy that is employed for scheduling the threads before the triggering event occurred. Automatically selecting is performed without human intervention.

These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A shows—a computer having a plurality of processors organized into various processor sets (PSETs).

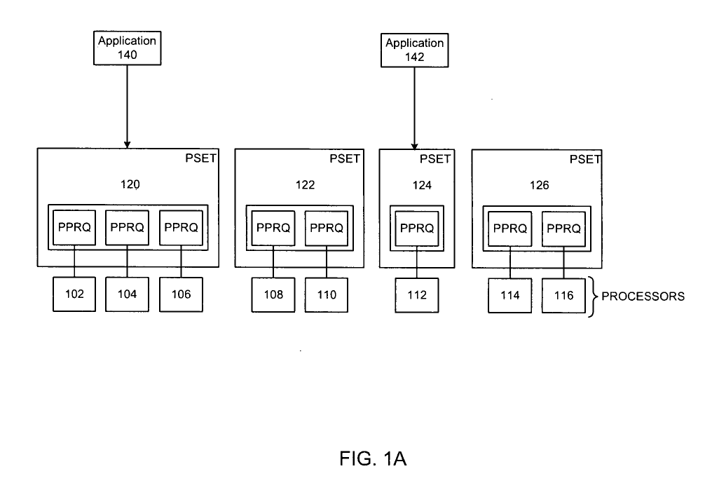

FIG. 1B shows the example scheduling resources that may be provided for a computer system.

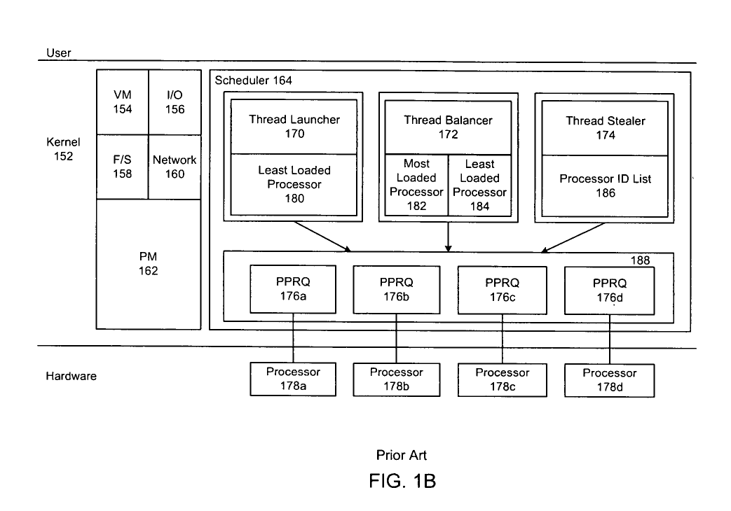

FIG. 1C shows a prior art approach for providing scheduling resources to multiple PSETs in a computer system.

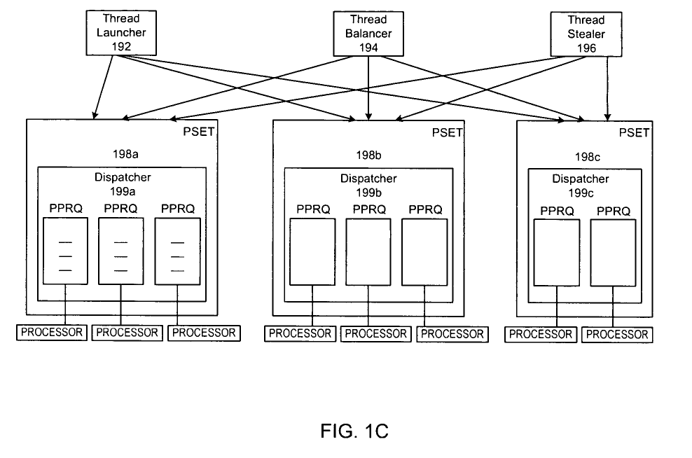

FIG. 2 shows, in accordance with an embodiment of the present invention, how a cooperative scheduling component may be employed to efficiently provide scheduling resources to processors in different PSETs of a computer system.

FIG. 3 shows, in accordance with an embodiment of the present invention, some of the input and output of a cooperative scheduling component to a thread launcher, a thread balancer, and a thread stealer.

FIG. 4 shows, in accordance with an embodiment of the present invention, example tasks performed by the cooperative scheduling component.

FIG. 5 shows, in accordance with an embodiment of the present invention, the steps taken by the cooperative scheduling component in calculating and providing unified scheduling related parameters to various scheduling components.

FIG. 6 shows, in accordance with an embodiment of the invention, an arrangement for administering scheduling resources on a per-PSET basis.

FIG. 7 shows, in an accordance of an embodiment of this invention, another arrangement for administering scheduling resources on a per-PSET basis.

FIG. 8 shows, in an accordance of an embodiment of this invention, yet another arrangement for administering scheduling resources on a per-PSET basis.

FIG. 9 shows, in accordance with an embodiment, a scheduling-enabled entity with a policy engine, which may includes a policy database, an APS, and a policy block.

FIG. 10 shows, in accordance with an embodiment of the present invention, steps taken by the automatic policy scheduling component in selecting the scheduling policy to be implemented based on the current scheduling configuration.

FIG. 11 shows, in accordance with an embodiment, a sequence of events that occurred with respect to a computer system to illustrate APS operation.

FIG. 12 shows, in accordance with an embodiment, yet another arrangement of a scheduling-enabled entity with a policy engine, which may include a policy database, an APS, and a policy block.

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described hereinbelow, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

In an embodiment of the invention, there is provided with a scheduler subsystem a cooperative scheduling component (CSC) configured to provide unified scheduling-related parameters (USRPs) pertaining to the system's processors to the thread launcher, the thread balancer, and the thread stealer in an operating system. In an embodiment, the CSC is configured to obtain system information in order to calculate scheduling-related parameters such as the most loaded processor, the least loaded processor, the starving processor(s), the non-starving processor(s), run-time behavior of threads, per-processor load information, NUMA (Non-Uniform Memory Access) topology, and the like. The scheduling-related parameters are then furnished to the thread launcher, the thread balancer, and the thread stealer to allow these components to perform their respective tasks.

Since the scheduling-related parameters are calculated by a single entity (i.e., the CSC), the prior art problem of having different components individually obtaining system data and calculating their own scheduling-related parameters at different times is avoided. In this manner, the CSC provides data coordination to prevent components from undoing each other's work.

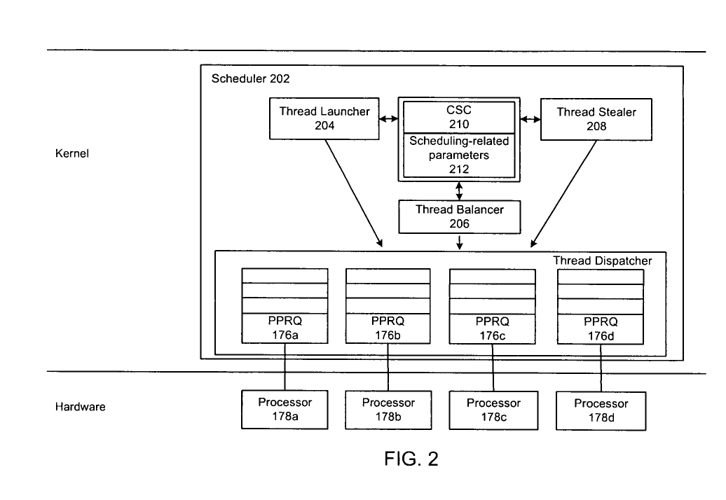

The features and advantages of embodiments of the invention may be better understood with reference to the figures and discussions that follow. FIG. 2 shows, in accordance with an embodiment of the present invention, a scheduler 202 having a thread launcher 204, a thread balancer 206, and a thread stealer 208. A cooperative scheduling component (CSC) 210 is configured to obtain system information, e.g., from the kernel, and to calculate scheduling-related parameters 212. CSC 210 is also shown coupled to communicate with thread launcher 204, thread balancer 206, and thread stealer 208 to provide any required subsets of scheduling-related parameters 212 to thread launcher 204, thread balancer 206, and thread stealer 208 to allow these components to perform their tasks.

By employing a single entity to obtain system data at various times and calculate the scheduling-related parameters using a single set of algorithms, embodiments of the invention ensure that thread launcher 204, thread balancer 206, and thread stealer 208 can obtain the same value when it requests the same scheduling parameter. For example, if both thread stealer 208 and thread balancer 206 request the identity of the most loaded processor, CSC 210 would be furnishing the same answer to both. This is in contrast to the prior art situation whereby thread stealer 208 may ascertain, using its own algorithm on data it obtained at some time (Tx), the most loaded processor and whereby thread balancer 206 may use a different algorithm on data it may have obtained at a different time (Ty) to ascertain the most loaded processor.

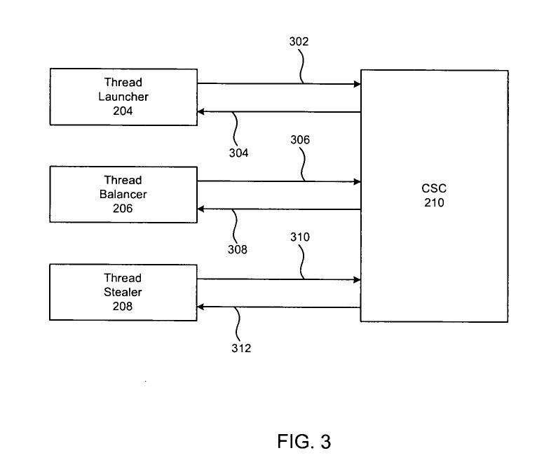

FIG. 3 shows, in accordance with an embodiment of the present invention, some of the input and output of CSC 210 to thread launcher 204, thread balancer 206, and thread stealer 208. As mentioned, CSC 210 is configured to obtain system data (such as processor usage pattern, thread run-time behavior, NUMA system topology, and the like) to calculate scheduling-related parameters for use by thread launcher 204, thread balancer 206, and thread stealer 208.

Thread launcher 204 may request the identity of a processor to launch a thread, which request is furnished to CSC 210 as an input 302. CSC 210 may then calculate, based on the data it obtains from the kernel pertaining to the thread's run-time behavior and the usage data pertaining to the processors for example, the identity of the processor to be furnished (output 304) to thread launcher 204.

Likewise, load balancer 206 may request (input 306) the set of most loaded processors and the set of least loaded processors, as well as the most suitable candidate threads to move from the set of the most loaded processors to the set of least loaded processors to achieve load balancing among the processors. These USRPs are then calculated by CSC 210 and furnished to thread balancer 206 (output 308). The calculation performed by CSC 210 of the most loaded processors and the least loaded processors may be based on per-processor usage data, which CSC 210 obtains from the kernel, for example. In an embodiment, the average usage level is established for the processors, along with an upper usage threshold and a lower usage threshold. Processors whose usage levels exceed the upper usage threshold may be deemed most loaded whereas processors whose usage levels fall below the lower usage threshold may be deemed least loaded. The candidate thread(s) may be obtained from the thread run-time behavior and NUMA topology data, for example. NUMA topology data may be relevant in the calculation since a thread may be executing more efficiently in a given NUMA domain and such consideration may be taken into account when determining whether a thread should be deemed a candidate to be evacuated.

Thread stealer 208 may request (input 310) the identity of the most loaded processor or processor in starvation state, along with the candidate thread to be moved away from that processor (input 3. Using the thread run-time behavior data, the per-processor load information, and/or NUMA topology data, CSC 210 ascertains the most loaded processor and candidate thread to furnish (output 312) those scheduling-related parameters to thread stealer 208.

Note that the scheduling parameters of FIG. 3, as well as the data employed for their calculations, are only examples. Different algorithms employed by CSC 210 may employ different data for their calculations. Likewise, different schedulers may employ a greater number of, fewer, or different scheduling parameters in their thread launcher, thread balancer, and thread stealer components.

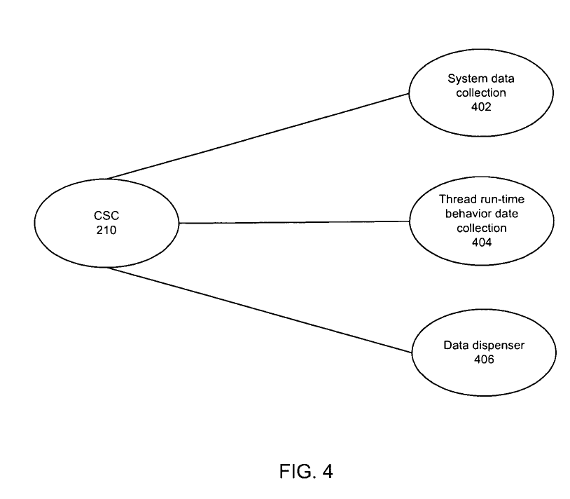

CSC 210 may be thought of as the unified mechanism that performs three main tasks: system information collection (402 in FIG. 4), thread run-time behavior data collection (404), and dispensing USRPs to the components (406) for use in their respective tasks. As mentioned, the system information (e.g., per processor load information, NUMA topology, etc.) may be obtained, in an embodiment, from the kernel periodically. In an embodiment, the collected system information is employed to compute the USRPs upon collection. The USRPs are then stored in a centralized storage area to be dispensed to the components upon request.

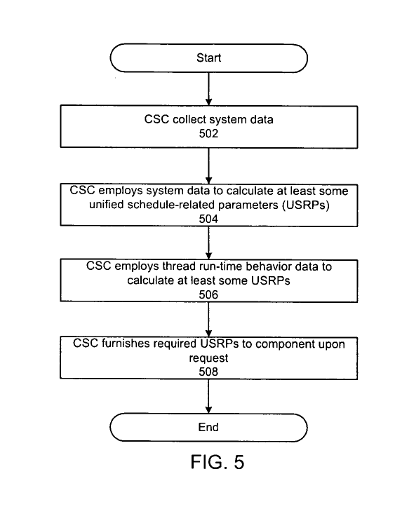

FIG. 5 shows, in accordance with an embodiment of the present invention, the steps taken to handle a request for scheduling-related parameters from one of the thread launcher, thread balancer, and thread stealer. In step 502, the system data is collected by the CSC. As mentioned, this data may take place on a periodic basis or on some pre-defined schedule. In step 504, the CSC employs the collected system data to compute at least some of the USRPs. In step 506, the CSC employs run-time behavior data to calculate other USRPs that require run-time behavior data in their calculations. In step 508, the required USRPs are furnished to the requesting component (e.g., one or more of the thread launcher, thread balancer, and thread stealer). Using the received USRPs, these components may then perform their respective tasks with minimal risks of adversely interfering with one another.

As can be appreciated from the foregoing, the invention prevents different components of the scheduling system from using conflicting data and/or data collected at different times and different schedules to calculate the same scheduling parameter (e.g., most loaded CPU). By using a single entity (e.g., the CSC) to calculate the required USRPs based on data collected by this single entity, the components are assured of receiving the same data when they request the same scheduling parameter. As such, the scheduler may be able to schedule the threads more efficiently since the probability of the components working against one another is substantially reduced.

Furthermore, when there are multiple PSETs in a computer system, the inventors herein realize that efficiency may be improved if scheduling resources (such as thread launching, thread balancing, and thread stealing) are administered on a PSET-by-PSET basis. For example, if a thread is assigned to a PSET for execution on one of the processors therein, that thread may be scheduled for execution on any processor of the PSET or moved among processors within a PSET if such action promotes efficiency and fairness with regard to the overall processor bandwidth of the PSET. To maintain processor partitioning integrity, that PSET is not scheduled to execute on a processor of a different PSET or moved to a processor associated with a different PSET. In this manner, efficiency in scheduling threads for execution is still achieved among the processors of a PSET.

Furthermore, the scheduling resources may apply different policies (e.g., thread launching policies, thread balancing policies, and/or thread stealing policies) to different PSETs if the scheduling requirements are different in the different PSETs. This is because, for example, a policy that may be efficient for a particular hardware topology of a PSET may be inefficient when applied in another PSET having a different hardware topology. As another example, a policy that may be efficient for threads of a particular application running in a different PSET may be inefficient for threads of a different application executing in a different PSET.

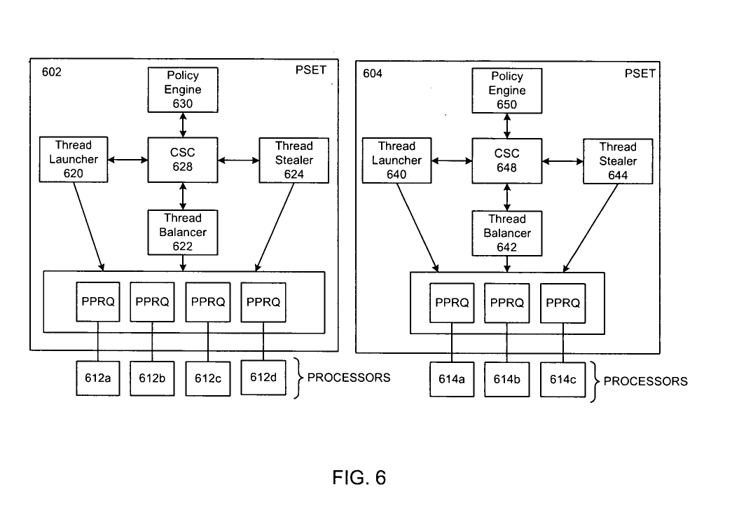

FIG. 6 shows, in accordance with an embodiment of the invention, an arrangement for administering scheduling resources on a per-PSET basis. In FIG. 6, there are shown two PSETs 602 and 604, representing two example PSETs of a computer system. Any number of PSETs may be created in a computer system if there is a need and there are enough processors to populate the PSETs. PSET 602 is shown having four processors 612a, 612b, 612c, and 612d. PSET 604 is shown having three processors 614a, 614b, and 614c.

As shown in FIG. 6, each of PSETs 602 and 604 has its own scheduling resources, such as its own thread launcher, its own thread balancer, and its own thread stealer. These are shown conceptually in FIG. 6 as thread stealer 620, thread balancer 622, and thread stealer 624 for PSET 602. Furthermore, thread stealer 620, thread balancer 622, and thread stealer 624 are coupled to communicate with a CSC 628 in order to receive scheduling-related parameters to enable these components to launch and/or move threads with respect to processors 612a, 612b, 612c, and 612d of PSET 602. CSC 628 is configured to obtain PSET system data pertaining to the processors of PSET 602 as well as run-time behavior data pertaining to the threads running on the processors of PSET 602 in order to calculate the aforementioned scheduling-related parameters.

CSC 628 is also shown coupled to a policy engine 630, which has access to a plurality of policies and is configured to provide PSET-specific policies for use in scheduling threads among the processors of PSET 602. In an embodiment, the system operator may set a policy attribute associated with a PSET when the PSET is created. The policy attribute indicates the policy/policies to be applied to the processors of PSET 602 when scheduling threads using one of thread stealer 620, thread balancer 622, and thread stealer 624. Note that the use of the CSC renders the provision of multiple selectable scheduling policies practical. If the scheduling components had been allowed to run their own algorithms, it would have been more complicated to provide different sets of selectable algorithms to individually accommodate the thread launcher, the thread balancer, and the thread stealer.

Likewise, PSET 604 is shown having its own thread stealer, thread balancer, and thread stealer. These are shown conceptually in FIG. 6 as thread stealer 640, thread balancer 642, and thread stealer 644 for PSET 604. Furthermore, thread stealer 640, thread balancer 642, and thread stealer 644 are coupled to communicate with a CSC 648 in order to receive scheduling-related parameters to enable these components to launch and/or move threads with respect to processors 614a, 614b, and 614c of PSET 604. CSC 648 is configured to obtain PSET system data pertaining to the processors of PSET 604 as well as run-time behavior data pertaining to the threads running on the processors of PSET 604 in order to calculate the aforementioned scheduling-related parameters.

CSC 648 is also shown coupled to a policy engine 650, which is configured to provide PSET-specific policies for use in scheduling threads among the processors of PSET 604. As mentioned, the system operator may set a policy attribute associated with a PSET when PSET 604 is created. The policy attribute indicates the policy/policies to be applied to the processors of PSET 604 when scheduling threads using one of thread stealer 640, thread balancer 642, and thread stealer 644.

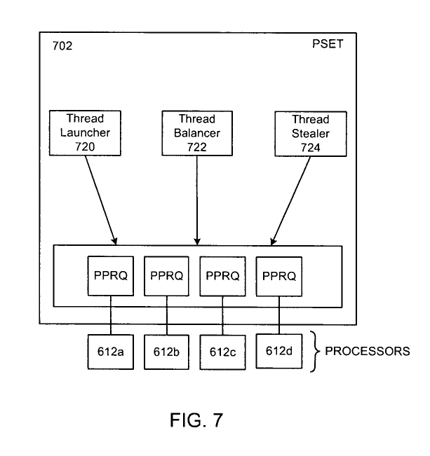

In an embodiment, the CSC may be omitted in one, some, or all of the PSETs. FIG. 7 shows this implementation wherein a PSET 702 is associated with its own scheduling resources (e.g., thread launcher 720, thread balancer 722, thread stealer 724). These scheduling resources may execute a set of policies in PSET 702 while the scheduling resources associated with another PSET would execute a different set of policies. For example, thread launcher 720 of PSET 702 may execute one thread launching policy while a thread launcher associated with another PSET would execute a different thread launching policy. Multiple selectable policies may be furnished or the policy/policies to be applied in a given PSET may be furnished by the system administrator upon creating that PSET.

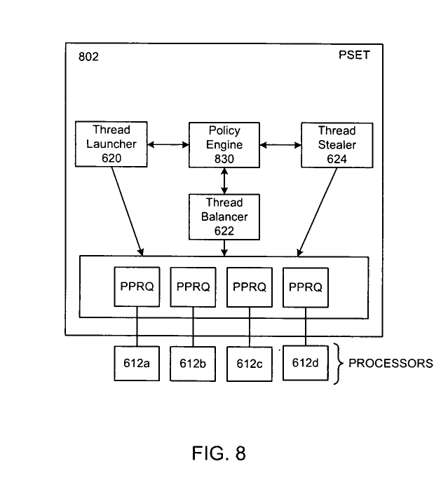

In an embodiment, a PSET may be furnished with a policy engine without a CSC. FIG. 8 shows this implementation wherein PSET 802 is associated with its own scheduling resources (e.g., thread launcher, thread balancer, thread stealer) and its own policy engine 830. The policy engine 830 allows the system administrator to choose among different available policy/policies to be administered by the scheduling resources of the PSET. For example, the system administrator may simply select one of the policies available with policy engine 830 as the thread balancing policy to be employed with the processors of PSET 830 given the hardware topology of PSET 802 and/or the run-time behavior of the threads assigned to execute on the processors of PSET 802. In this case, another PSET in the system may employ a different thread balancing policy given its own hardware topology and/or the run-time behavior of threads assigned to execute on its processors.

As can be appreciated from the foregoing, embodiments of the invention enable different PSETs to have different policies for their scheduling components (e.g., thread launcher, thread balancer and/or thread stealer). With this capability, the system administrator may be able to improve performance by designating different PSETs to execute different scheduling policies based on the hardware topology of individual PSETs and/or the run-time behavior of threads assigned to execute in those individual PSETs. The provision of a CSC within each PSET further improves the scheduling performance on a per-PSET basis since the scheduling components may coordinate their efforts through the CSC of the PSET.

As mentioned, a policy engine may be provided to select a scheduling policy for a PSET. There are times, however, when a change in the scheduling policy is desirable when certain triggering events occur. For example, the system may be booted up with one scheduling policy. Subsequently, the hardware and/or software configuration of the computer system or of a PSET therein (if the system employs PSETs) may change, which renders scheduling in accordance with the previously selected scheduling policy inefficient. As another example, the system administrator may, subsequent to boot up, decide to change the scheduling goal, for example from a fair share approach to a non-fair share approach. In this case, the scheduling policy needs to be changed to implement the change in the scheduling goal.

In accordance with embodiments of the present invention, the policy engine is furnished with an automatic policy selector (APS). When the APS is executed, the appropriate scheduling policy is selected in view of the current scheduling configuration. As the term is employed herein, the scheduling configuration refers to the hardware and/or software configuration of the computer system or of the affiliated PSET (if the computer system implements PSETs), and/or the scheduling goal specified by the human operator. The APS may be executed on a periodic basis (i.e., the periodic time occurrence serves as a triggering event) or may be executed upon the occurrence of certain triggering events (such as a change in the hardware and/or software configuration or a change in the scheduling goal). The selected scheduling policy is then regarded by the policy engine as the current scheduling policy to be carried out by scheduler's components

In an embodiment, the APS-enabled policy engine automatically furnishes the selected scheduling policy to the CSC. Unless the automatically furnished scheduling policy (which may be a single policy or a set of policies) is over-ridden, the CSC employs that automatically furnished scheduling policy to calculate the Unified Scheduling-Related Parameters (USRPs) for use by components of the scheduler (such as by the thread launcher, the thread balancer, and the thread stealer).

Note that the APS-enabled policy engine may perform its task of selecting and furnishing an appropriate scheduling policy to the scheduler's components irrespective whether a CSC is employed. An example arrangement whereby the APS is employed in conjunction with a policy engine is illustrated in FIG. 6, and an example arrangement whereby the APS is employed without using the CSC engine is shown in FIG. 8. In the example of FIG. 8, each of the scheduler's components may employ the furnished scheduling policy to derive its own scheduling parameters.

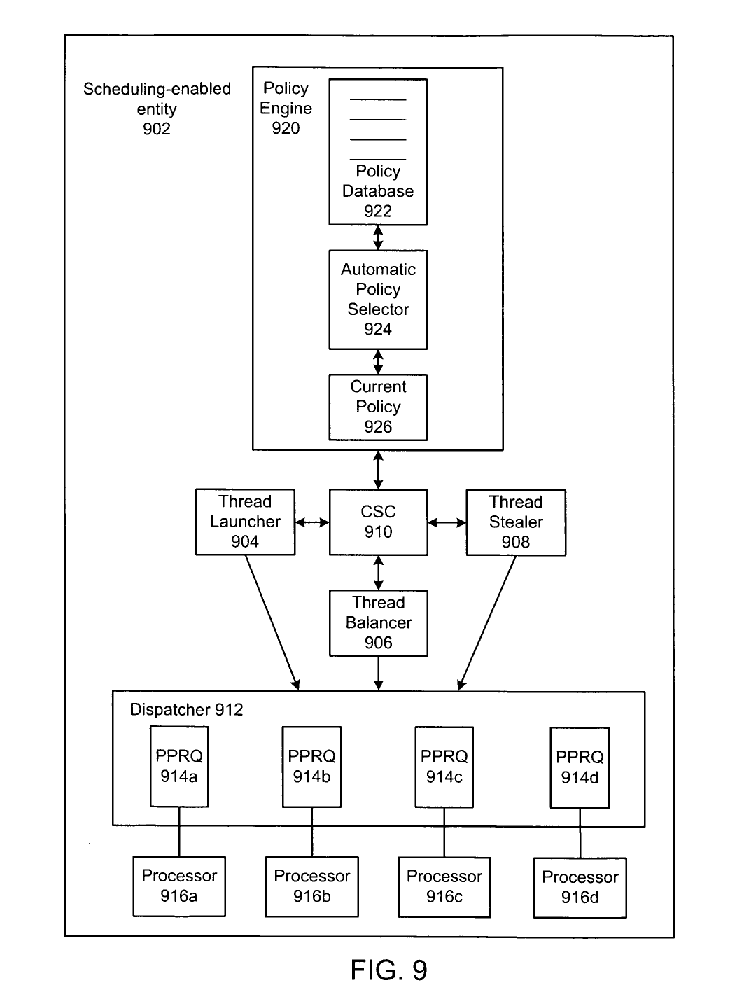

To facilitate discussion, FIG. 9 shows, in accordance with an embodiment, a scheduling-enabled entity 902. As the term is employed herein, a scheduling-enabled entity represents a computer system or one of the PSETs therein if the computer system employs PSETs. In FIG. 9, thread launcher 904, thread balancer 906, thread stealer 908, and CSC 910 correspond to the thread launcher, the thread balancer, the thread stealer, and the CSC discussed earlier herein and will not be further elaborated for brevity's sake. Similarly, dispatcher 912, PPRQs 914a-914d, and processors 916a-916d correspond to the dispatcher, the per-processor run queues, and the processors discussed herein and will not be further elaborated for brevity's sake.

Policy engine 920 includes a policy database 922, an automatic policy selector (APS) 924, and a current policy block 926. Policy database 922 represents the policy database wherein various scheduling policies designed to accommodate different hardware and/or software configuration for the scheduling-enabled entity or to accommodate different scheduling goals set by the human operator for the scheduling-enabled entity. Automatic Policy Selector (APS) 924 represents the logic component for selecting a set of policies (which can be one or multiple policies) to implement for the scheduling-enabled entity. The current policy block 926 represents the scheduling policy chosen by APS 924 and currently in effect for scheduling-enabled entity 902.

Note that FIG. 9 only shows one APS 924. If there is more than one PSETs, each PSET in which automatic policy scheduling selection is implemented would have its own APS.

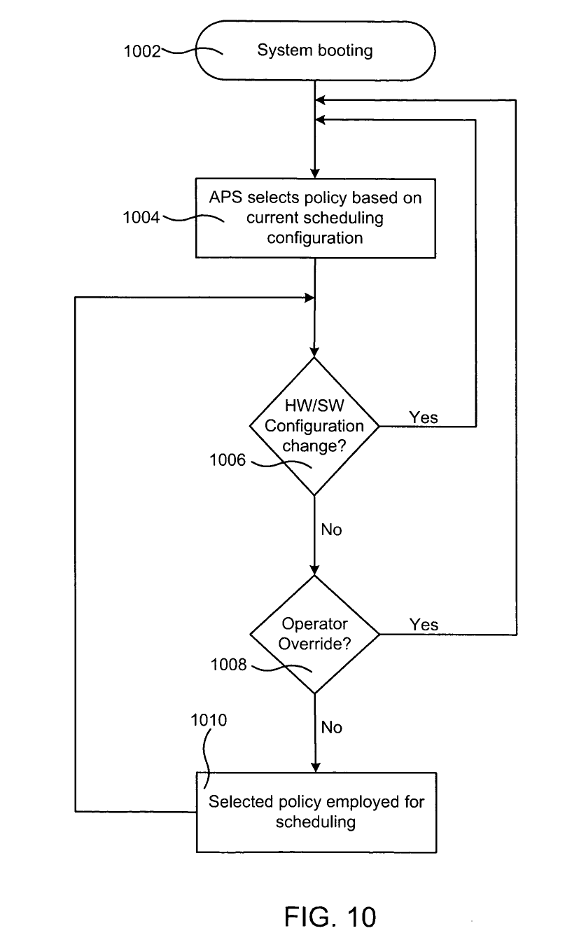

FIG. 10 shows, in accordance with an embodiment of the present invention, the operation of APS 924. Step 1002 represents the computer system booting up. Thereafter, steps 1004-1010 are performed for each scheduling-enabled entity (i.e., for the entire computer system or for each PSET if the PSET paradigm is employed). In step 1004, the APS selects the scheduling policy to be implemented based on the current scheduling configuration (such as the hardware/software configuration or the operator-specified scheduling goal) that the APS detects.

In step 1006, it is ascertained whether there has been a hardware and/or software configuration change in the scheduling-enabled entity since the policy was selected. If there has been a hardware and/or software configuration change since the policy was selected, the APS is invoked to select the scheduling policy based on the changed hardware and/or software configuration (path YES from block 1006 back to block 1004).

After the APS has selected a new scheduling policy in block 1004, if there has been no new hardware and/or software configuration change that necessitates a new scheduling policy (as ascertained in block 1006), it is ascertained in step 1008 whether there has been an operator override that has not been serviced. The operator override represents an action by the operator that indicates that the operator wishes to apply a different scheduling policy. The action taken may be an explicit instruction from the operator to apply a particular scheduling policy or may represent a change in the scheduling goal.

If there is an operator override, the APS selects a new scheduling policy based on the override action by the operator (path YES from block 1008 back to block 1004). Thus, whenever there is a new hardware and/or software configuration change or whenever there is an outstanding operator override request, the APS is invoked to select a new scheduling policy based on the latest scheduling configuration.

On the other hand, if there is neither a new hardware and/nor software configuration change nor an outstanding operator override request, the selected policy is employed for scheduling purposes (block 1010). Thereafter, the method returns to step 1006 to monitor for a change in either the hardware/software configuration or in the scheduling goal specified by the operator.

In an embodiment, the method may perform a scheduling performance analysis at certain times (e.g., upon the occurrence of some predefined events or periodically) to ascertain whether the existing scheduling policy for the scheduling-enabled entity should be replaced by another scheduling policy to improve scheduling efficiency and/or fairness. If it is ascertained that the existing scheduling policy for the scheduling-enabled entity is less efficient than desired and should be replaced by another scheduling policy to improve scheduling efficiency and/or fairness, the APS includes logic to select a different scheduling policy. For example, the operator may specify in advance that if a scheduling efficiency threshold is not achieved, the APS should try one or more specified scheduling policies from a predefined list (which list may be specific to a hardware and/or software configuration) and monitor for improvement.

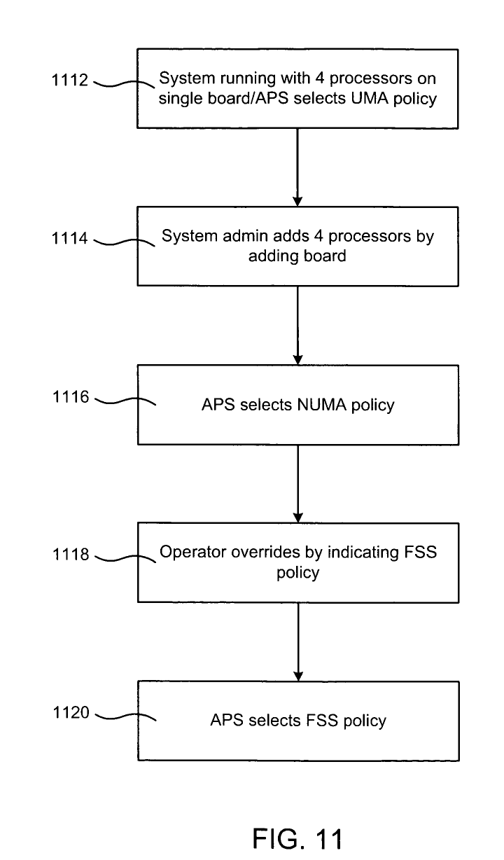

FIG. 11 shows, in accordance with an embodiment, a sequence of events that occurred with respect to a computer system to illustrate APS operation. Responsive to the events, the scheduling policy is changed by the APS.

In step 1112, a computer system having 4 processors is running with all four processors being implemented on the same board. Accordingly, there are no memory locality issues, and the policy selected may be, for example, one that implements Uniform Memory Access (UMA) scheduling.

In step 1114, the system administrator adds four additional processors to the computer system by adding another processor board, for example. When the APS is executed in step 1116 (e.g., periodically or upon the occurrence of the hardware configuration change), the APS detects that the hardware configuration has changed from a UMA model to a Non-Uniform-Memory Access model. Accordingly, the APS selects one of the NUMA scheduling policy as the policy to be implemented.

In step 1116, the policy engine implements the new NUMA scheduling policy, replacing the earlier UMA scheduling policy.

In step 1118, suppose the system administrator indicates that he wishes to implement fair share scheduling (FSS) policy. Via an interface furnished by the APS, the operator is able to, for example, set the current policy to be one that implements FSS. The scheduling policy that is set by the human operator override action via the APS is then employed for scheduling by the scheduler's components (step 1120).

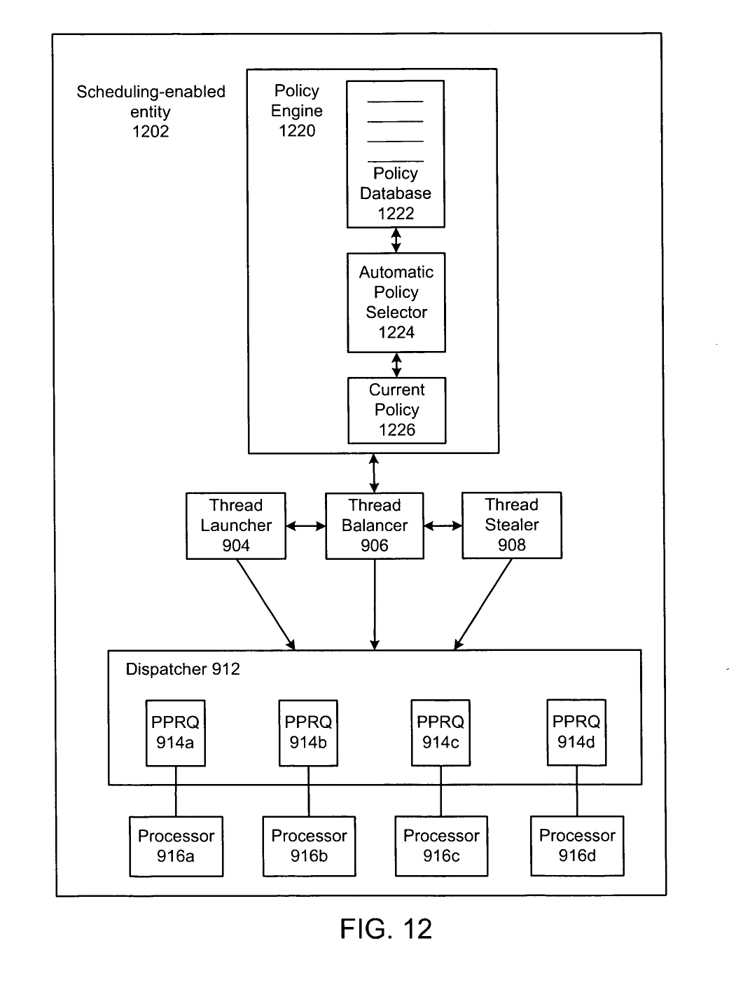

As mentioned, it is possible to employ the APS to improve scheduling efficiency without requiring the use of a CSC. FIG. 12 shows an example implementation wherein the CSC is not required. In FIG. 12, thread launcher 904, thread balancer 906, thread stealer 908, and CSC 910 correspond to the thread launcher, the thread balancer, the thread stealer, and the CSC discussed earlier herein and will not be further elaborated for brevity's sake. Similarly, dispatcher 912, PPRQs 914a-914d, and processors 916a-916d correspond to the dispatcher, the per-processor run queues, and the processors discussed herein and will not be further elaborated for brevity's sake.

Policy engine 1220 includes a policy database 1222, an automatic policy selector (APS) 1224, and a current policy block 1226. Policy database 1222 represents the policy database wherein various scheduling policies designed to accommodate different hardware and/or software configuration for the scheduling-enabled entity or to accommodate different scheduling goals set by the human operator for the scheduling-enabled entity. Automatic Policy Selector (APS) 1224 represents the logic component for selecting a set of policies (which can be one or multiple policies) to implement for the scheduling-enabled entity. The current policy block 1226 represents the scheduling policy chosen by APS 1224 and currently in effect for the scheduling-enabled entity.

As shown in FIG. 12, no CSC is required and the current policy selected (in block 1226) may be employed directly by the scheduler components (e.g., the thread launcher, the thread balancer, and the thread stealer) in their respective scheduling tasks.

As can be appreciated from the foregoing, embodiments of the invention automatically provides recommendations with regard to the current scheduling policy to be implemented for the scheduling-enabled entity (e.g., the system or a PSET therein). The recommendation is taken from a database of policies and is based on the hardware and/or software configuration of the scheduling-enabled entity (which may be automatically ascertained by the APS via an auto-discovery mechanism, for example) and/or based on the scheduling goal set by the human operator. Once the current scheduling policy is automatically selected, the human operator has an option of getting involved, in an embodiment, to change the selected policy to another policy if such change is desired.

Thereafter, the current scheduling policy is executed, either by the CSC or by the individual scheduler components in order to schedule threads for execution by the various processors. Since the selection and/or implementation of the scheduling policy is automatic for the scheduling-enabled entity, embodiments of the invention substantially eliminate human-related errors in setting/changing scheduling policies. Further, embodiments of the invention are highly scalable to large systems wherein there may be a large number of scheduling-enabled entities (e.g., PSETs). By implementing embodiments of the invention, the human operator no longer needs to be involved in manually determining/setting/changing the scheduling policy for a large number of PSETs whenever there is an event that may impact scheduling, such as when the hardware/software configuration changes or when the scheduling goal changes.

While this invention has been described in terms of several embodiments, there are alterations, permutations, and equivalents, which fall within the scope of this invention. For example, although the detailed description herein is discussed in connection with PSETs, the techniques disclosed herein would apply to any type of scheduling allocation domain. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. In a computer system, an arrangement for coordinating scheduling of threads on a plurality of processors associated with a scheduling-enabled entity, comprising:
a policy database having a plurality of scheduling policies; and
an automatic policy selector associated with said scheduling-enabled entity, said automatic policy selector being configured to automatically select one of said plurality of scheduling policies responsive to a triggering event from a set of triggering events that includes at least one of a first event and a second event, said first event representing a change in configuration of said scheduling-enabled entity, said second event representing a policy selection from a human operator, whereby said one of said plurality of scheduling policies is employed to schedule said threads on said plurality of processors after being selected by said automatic policy selector.

2. The arrangement of claim 1 wherein said scheduling-enabled entity further comprises a set of scheduling resources, said set of scheduling resources including at least two of a thread launcher, a thread balancer, and a thread stealer, said at least one of said plurality of scheduling policies being employed by a set of scheduling resources to perform said scheduling said threads on said plurality of processors.

3. The arrangement of claim 2 wherein said scheduling-enabled entity includes a cooperative scheduling component (CSC) coupled to communicate with said automatic policy selector and said at least two of said thread launcher, said thread balancer, and said thread stealer, said CSC being configured to provide unified scheduling-related parameters (USRPs) for use by said at least two of said thread launcher, said thread balancer, and said thread stealer in scheduling said threads on said plurality of processors.

4. The arrangement of claim 2 wherein said set of scheduling resources includes all three of said thread launcher, said thread balancer, and said thread stealer.

5. The arrangement of claim 1 wherein said triggering event represents said first event, said change in configuration of said scheduling-enabled entity represents a hardware change.

6. The arrangement of claim 1 wherein said triggering event represents said first event, said change in configuration of said scheduling-enabled entity represents a software change.

7. The arrangement of claim 1 wherein said scheduling-enabled entity represents a first processor set (PSET), said computer system further having a second PSET, said second PSET having a different plurality of processors that is different from said plurality of processors.

8. The arrangement of claim 1 wherein said set of triggering events includes a third event, said third event occurring when scheduling efficiency in said schedule-enabled entity falls below a scheduling efficiency threshold.

9. The arrangement of claim 8 wherein said triggering event represents said third event, said at least one of said plurality of scheduling policies, when selected responsive to an occurrence of said third event, representing a scheduling policy that is different from a scheduling policy in use for said scheduling-enabled entity prior to said third event.

10. The arrangement of claim 1 wherein said triggering event represents said first event.

11. The arrangement of claim 1 wherein said triggering event represents said second event.

12. The arrangement of claim 1 wherein said set of triggering event includes a fourth event, said fourth event representing a periodic time occurrence.

13. The arrangement of claim 12 wherein said triggering event represents said fourth event, said at least one of said plurality of policies being selected automatically by said automatic policy selector in view of said configuration of said scheduling-enabled entity.

14. In a computer system having a plurality of processor sets (PSETs), an arrangement for scheduling threads on a first plurality of processors associated with a first processor set (PSET) of said plurality of PSETs, comprising:
a first set of scheduling resources associated with said first PSET, said first set of scheduling resources including at least at least two of a first thread launcher, a first thread balancer, and a first thread stealer, said set of scheduling resources being configured to schedule threads assigned to said first PSET only among said first plurality of processors;
a policy database having a plurality of scheduling policies; and
an automatic policy selector associated with said first PSET, said automatic policy selector being configured to automatically select one of said plurality of scheduling policies responsive to a triggering event from a set of triggering events that includes at least one of a first event and a second event, said first event representing a change in configuration of said scheduling-enabled entity, said second event representing a policy selection from a human operator, whereby said one of said plurality of scheduling policies is employed by said first set of scheduling resources to schedule said threads on said first plurality of processors after being selected by said automatic policy selector.

15. The arrangement of claim 14 wherein said first PSET includes a first cooperative scheduling component (CSC) coupled to communicate with said automatic policy selector and said first set of scheduling resources, said first CSC being configured to provide unified scheduling-related parameters (USRPs) for use by said first set of scheduling resources in scheduling said threads on said first plurality of processors.

16. The arrangement of claim 15 wherein said set of scheduling resources includes all three of said thread launcher, said thread balancer, and said thread stealer.

17. The arrangement of claim 14 wherein said triggering event represents said first event, said change in configuration of said scheduling-enabled entity represents a hardware change.

18. The arrangement of claim 14 wherein said triggering event represents said first event, said change in configuration of said scheduling-enabled entity represents a software change.

19. The arrangement of claim 14 wherein said set of triggering events includes a third event, said third event occurring when scheduling efficiency in said first PSET falls below a scheduling efficiency threshold.

20. The arrangement of claim 19 wherein said triggering event represents said third event, said at least one of said plurality of scheduling policies, when selected responsive to an occurrence of said third event, representing a scheduling policy that is different from a scheduling policy in use for said first PSET prior to said third event.

21. The arrangement of claim 14 wherein said triggering event represents said first event.

22. The arrangement of claim 14 wherein said triggering event represents said second event.

23. The arrangement of claim 14 wherein said set of triggering event includes a fourth event, said fourth event representing a periodic time occurrence.

24. The arrangement of claim 23 wherein said triggering event represents said fourth event, said at least one of said plurality of policies being selected automatically by said automatic policy selector in view of said configuration of said first PSET.

25. In a computer system, a method for scheduling threads on a plurality of processors associated with a scheduling-enabled entity, comprising:
ascertaining whether a triggering event has occurred;
if said triggering event has occurred, automatically selecting a first scheduling policy, using an automatic policy selector, from a database of scheduling policies, said first scheduling policy representing a scheduling policy employed for scheduling said threads on said plurality of processors after said triggering event occurred, said first scheduling policy being different than a policy that is employed for said scheduling said threads before said triggering event occurred, whereby said automatically selecting is performed without human intervention.

26. The method of claim 25 wherein said triggering event represents one of a set of triggering events, said set of triggering events includes at least one of a first event, a second event, a third event, and a fourth event, said first event representing a change in configuration of said scheduling-enabled entity, said second event representing a policy selection from a human operator, said third event representing a periodic time occurrence, said fourth event representing a failure to reach a predefined scheduling efficiency threshold for said plurality of processors.

27. The method of claim 25 wherein said scheduling-enabled entity includes a set of scheduling resources, said set of scheduling resources including at least two of a thread launcher, a thread balancer, and a thread stealer, said first scheduling policy being employed by a set of scheduling resources to perform said scheduling said threads on said plurality of processors.

28. The method of claim 25 further comprising providing said first scheduling policy to a cooperative scheduling component (CSC) associated with said scheduling-enabled entity, said CSC being configured to provide unified scheduling-related parameters (USRPs) responsive to said first scheduling policy, said USRPs being employed by said set of scheduling resources in scheduling said threads on said plurality of processors.

29. The method of claim 25 wherein said set of scheduling resources includes all three of said thread launcher, said thread balancer, and said thread stealer.

30. The method of claim 25 wherein said triggering event represents said first event, said change in configuration of said scheduling-enabled entity represents a hardware change.

31. The method of claim 25 wherein said triggering event represents said first event, said change in configuration of said scheduling-enabled entity represents a software change.

32. The method of claim 25 wherein said scheduling-enabled entity represents a first processor set (PSET), said computer system further having a second PSET, said second PSET having a different plurality of processors that is different from said plurality of processors.

33. The method of claim 25 wherein said triggering event represents said third event.

34. The method of claim 25 wherein said triggering event represents said fourth event.

35. An article of manufacture comprising a program storage medium having computer readable code embodied therein, said computer readable code being configured to schedule threads on a plurality of processors associated with a scheduling-enabled entity, comprising:
computer readable code for ascertaining whether a triggering event has occurred;
computer readable code for automatically selecting, if said triggering event has occurred, a first scheduling policy from a database of scheduling policies, said first scheduling policy representing a scheduling policy employed for scheduling said threads on said plurality of processors after said triggering event occurred, said first scheduling policy being different than a policy that is employed for said scheduling said threads before said triggering event occurred, whereby said automatically selecting is performed without human intervention.

36. The article of manufacture of claim 35 wherein said triggering event represents one of a set of triggering events, said set of triggering events includes at least one of a first event, a second event, a third event, and a fourth event, said first event representing a change in configuration of said scheduling-enabled entity, said second event representing a policy selection from a human operator, said third event representing a periodic time occurrence, said fourth event representing a failure to reach a predefined scheduling efficiency threshold for said plurality of processors.

37. The article of manufacture of claim 36 wherein said triggering event represents said first event, said change in configuration represents a hardware change.

38. The article of manufacture of claim 36 wherein said triggering event represents said first event, said change in configuration represents a software change.

39. The article of manufacture of claim 35 wherein said scheduling-enabled entity includes a set of scheduling resources, said set of scheduling resources including at least two of a thread launcher, a thread balancer, and a thread stealer, said first scheduling policy being employed by a set of scheduling resources to perform said scheduling said threads on said plurality of processors.

40. The article of manufacture of claim 35 further comprising providing said first scheduling policy to a cooperative scheduling component (CSC) associated with said scheduling-enabled entity, said CSC being configured to provide unified scheduling-related parameters (USRPs) responsive to said first scheduling policy, said USRPs being employed by said set of scheduling resources in scheduling said threads on said plurality of processors.

41. The article of manufacture of claim 35 wherein said scheduling-enabled entity represents a first processor set (PSET), said computer system further having a second PSET, said second PSET having a different plurality of processors that is different from said plurality of processors.
